(19) United States
(12) Patent Application Publication
(10) Pub. No.: US 2008/0252660 A1
(43) Pub. Date: Oct. 16, 2008

(54) CURVED LINE CORRECTION METHOD, APPARATUS, AND PROGRAM

(75) Inventors: Jun MASUMOTO, Ichikawa-shi (JP); Osamu MIZUNO, Tokyo (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/100,193

(22) Filed: Apr. 9, 2008

(30) Foreign Application Priority Data
Apr. 10, 2007 (JP) 2007-102330

(51) Int. Cl. G09G 5/00

(52) U.S. Cl. 345/642; 345/442

(57) ABSTRACT

A curved line correction method is provided, which is used when correcting a curved line displayed on an image display device and formed of a plurality of dots by moving a dot selected from the plurality of dots. The method includes the steps of correcting a portion of the trajectory of the curved line such that the trajectory passes those of the plurality of dots located outside of an adjacent region of the selected dot before the dot is moved and a position of the selected dot after moved, and arranging a plurality of new dots on the corrected portion of the trajectory according to the length thereof.

### BACKGROUND OF THE INVENTION

1. Field of the Invention

The present invention relates to a curved line correction method for correcting a curved line displayed on a display device and formed of a plurality of dots by moving a dot selected from the plurality of dots.

2. Description of the Related Art

In the medical field, processing for automatically extracting a contour of a target region, such as a region of a predetermined organ, in a medical image and displaying the contour on an image display device is performed, in order to providing an image that ensures high diagnostic performance.

There are cases, however, in which a contour of a target region is not correctly extracted solely by the automatic extraction processing using a computer, and manual correction is required for a curved line obtained through the automatic extraction as the contour of the target region in order to obtain a desired contour.

As for the curved line correction method by manual operation described above, a method in which a dot selected from a plurality of dots on a curved line is moved by an operator, and using a displaced amount of the dot, a displacement amount of another dot is determined to maintain smoothness of the entire curved line even after correction is proposed as described, for example, in Japanese Unexamined Patent Publication No. 10(1998)-293859.

In the curved line correction method described in Japanese Unexamined Patent Publication No. 10(1998)-293859, however, the number of dots on a curved line is constant before and after correction. Therefore, if the length of a curved line is changed by the correction of the curved line, the spacing between adjacent dots is changed, so that the operator needs to understand the distribution state of a plurality of dots condensed or dispersed according to the change in the spacing first in the subsequent correction, and then to select an appropriate one of such plurality of dots, which may possibly causes inefficient work of the operator.

Further, as the length of a curved line becomes long through the correction of the curved line, the spacing between adjacent dots becomes great. This may possibly create a portion where a dot used for correcting the curved line does not exit, or the number of such portions is increased, thereby a correctable portion of the curved line is limited.

In view of the circumstances described above, it is an object of the present invention to provide a curved line correction method and apparatus capable of improving work efficiency of an operator and allowing correction of a curved line at an arbitrary position on the line. It is a further object of the present invention to provide a computer program product therefor.

### SUMMARY OF THE INVENTION

The curved line correction method of the present invention is a curved line correction method for correcting a curved line displayed on an image display device and formed of a plurality of dots by moving a dot selected from the plurality of dots, the method including the steps of:

correcting a portion of the trajectory of the curved line such that the trajectory passes those of the plurality of dots located outside of an adjacent region of the selected dot before the dot is moved and a position of the selected dot after moved; and

arranging a plurality of new dots on the corrected portion of the trajectory according to the length thereof.

The term “an adjacent region of the selected dot before the dot is moved” is not limited to a region having a predetermined size around the selected dot, and may also be a region of a predetermined distance from the dot along the curved line.

The curved line correction apparatus of the present invention includes a trajectory correction mean and a dot arrangement means for implementing the curved line correction method described above.

The computer program product of the present invention is a program product for causing a computer to perform the curved line correction method described above.

According to the curved line correction method, apparatus, and program product of the present invention, when correcting a curved line displayed on an image display device and formed of a plurality of dots by moving a dot selected from the plurality of dots, a portion of the trajectory of the curved line is corrected such that the trajectory passes those of the plurality of dots located outside of an adjacent region of the selected dot before the dot is moved and a position of the selected dot after moved, and a plurality of new dots is arranged on the corrected portion of the trajectory according to the length thereof. This allows the dots on the curved line to be constantly maintained in a predetermined distribution before and after correction, thereby work efficiency of an operator may be improved. Further, the spacing between adjacent dots is maintained at or less than a predetermined value, so that a correction may be performed at any position on the curved line in the subsection correction.

### BRIEF DESCRIPTION OF THE DRAWINGS

FIG. 1 is a schematic block diagram of the curved line correction apparatus according to an embodiment of the present invention, illustrating an overall configuration thereof.

FIG. 2 illustrates an example formation of a curved line in the curved line correction apparatus shown in FIG. 1.

FIG. 3 illustrates an example adjacent region determined by the region determination means 10 shown in FIG. 1.

FIG. 4 illustrates an example trajectory portion of a curved line corrected by the trajectory correction means 30 shown in FIG. 1.

FIG. 5 illustrates an example of a plurality of new dots arranged by the dot arrangement means 40 shown in FIG. 1.

### DESCRIPTION OF THE PREFERRED EMBODIMENTS

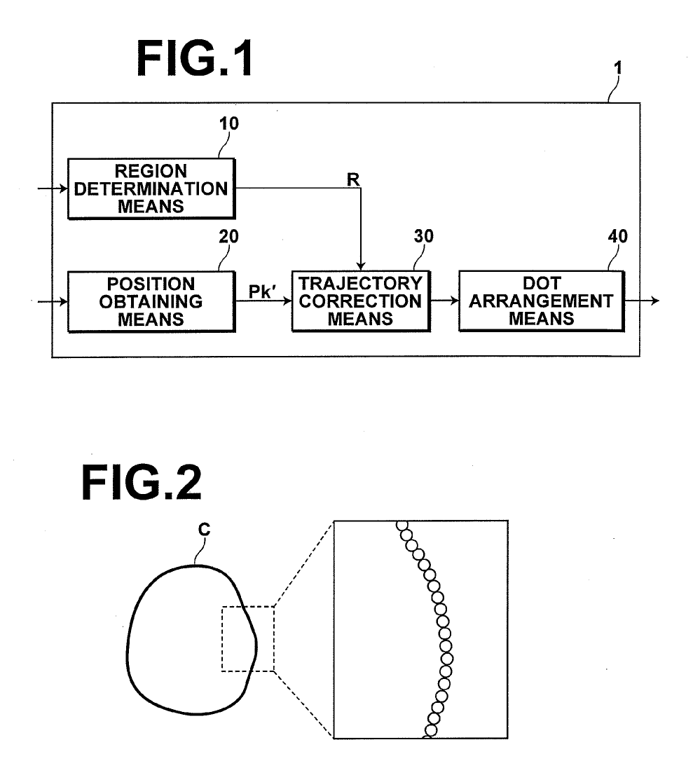

Hereinafter, an exemplary embodiment of the curved line correction apparatus of the present invention will be described with reference to the accompanying drawings. The curved line correction apparatus 1 according to an embodiment of the present invention shown in FIG. 1 is realized by executing a curved line correction program stored in an auxiliary storage unit on a computer (such as a personal computer). Here, the curved line correction program is recorded on an information storage medium, such as a CD-ROM, or distributed through a network, such as the Internet, and installed on the computer.

The curved line correction apparatus 1 according to the present embodiment is an apparatus for selecting an arbitrary one of a plurality of dots forming a curved line C displayed on a display device and moving the dot according to an operator input through a position specifying means, such as a keyboard or a mouse, capable of specifying a arbitrary position on an image display device, or the like, and correcting a portion of the curved line C following the movement of the selected dot. The apparatus includes a region determination means 10, a position obtaining means 20, a trajectory correction means 30, and a dot arrangement means 40.

Here, the curved line C is formed of a plurality of dots arranged at predetermined short spacing, as shown in FIG. 2. The operator may specify an arbitrary position on the curved line C without regarding the spacing and select a dot located at the specified position or at a position slightly away from the specified position.

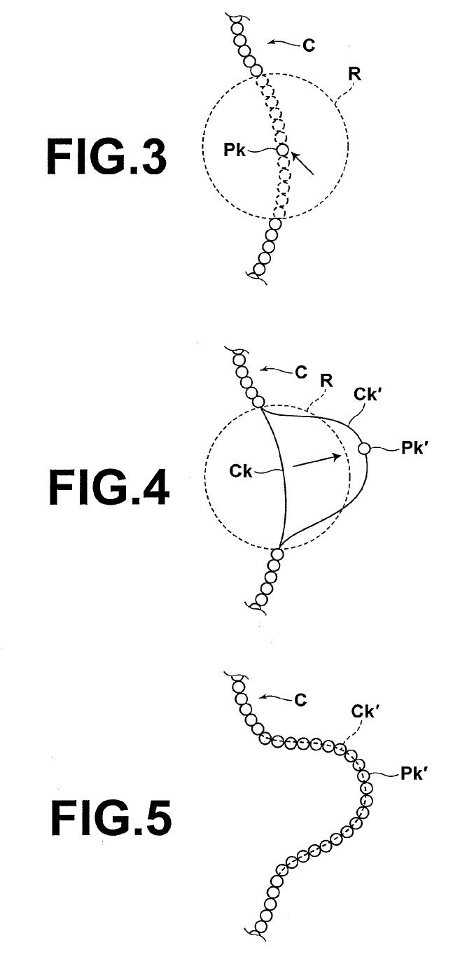

The region determination means 10 determines an adjacent region R of a dot Pk on the curved line C selected by the position specifying means. For example, as shown in FIG. 3, it determines a region having a predetermined size with the center roughly located at the position of the dot Pk as the adjacent region R. Here, the size of the adjacent region R may be set to an arbitrary size, and the periphery thereof may be of any shape such as a rectangle, an ellipsoid, or the like, other than a circle.

The adjacent region R of the dot Pk is not limited to the region having a predetermined size with the center roughly located at the position of the dot Pk and of any of the shapes described above. It may be a region of a predetermined distance from the dot Pk along the curved line C.

The position obtaining means 20 obtains a position Pk′ specified by the position specifying means 60 as the post movement position of the dot Pk after the dot Pk is selected.

The trajectory correction means 30 corrects a portion of the trajectory of the curved line C such that the trajectory passes the dots on the curved line C located outside of the adjacent region R before the dot Pk is moved and the position Pk′, which is a position of the dot Pk after moved. For example, the trajectory correction means 30 changes a portion Ck of the trajectory of the curved line C located within the adjacent region R to a new trajectory Ck′ as shown in FIG. 4. The new trajectory Ck′ is a smooth curve, such as a spline curve, connecting the post movement position Pk′ of the dot Pk and the dots located outside of the adjacent region R before the dot Pk is moved, so that a smoothly continuing curve is formed by the overall trajectory of the curved line C after correction.

The dot arrangement means 40 arranges a plurality of dots on the portion Ck′ of the trajectory, which is corrected by the trajectory correction means 30, according to the length of the trajectory. As shown in FIG. 5, a number of new dots are arranged on the corrected trajectory portion Ck′ according to the length thereof so that a plurality of dots is arranged at substantially constant short spacing over the entire curved line C. If the corrected portion Ck′ of the trajectory is shorter than the trajectory Ck before correction, a less number of new dots is arranged on the trajectory Ck′ according to the shortened length, and if the corrected portion Ck′ of the trajectory is longer than the trajectory Ck before correction, a more number of new dots is arranged on the trajectory Ck′ according to the elongated length.

When correcting a curved line C by the curved line correction apparatus configured in the manner as described above, the following steps are performed. First, an arbitrary dot on the curved line C is specified by the position specifying means (Step 1). Next, a dot Pk on the curved line C located at the specified position or at a position slightly away from the specified position is selected (Step 2). Then, an adjacent region R having a predetermined size with the center roughly located at the position of the selected dot Pk is determined (Step 3). Next, an arbitrary position Pk′ is specified on the image display device 50 by the position specifying means (Step 4), and the specified position Pk′ is obtained by the position obtaining means 20 as the position of the dot Pk after moved (Step 5). Thereafter, a portion of the trajectory Ck of the curved line C is changed by the trajectory correction means 30 to a new trajectory Ck′ such that the trajectory of the curved line C passes the dots on the curved line C located outside of the adjacent region R determined in Step 3 and the position of the dot Pk after moved obtained in Step 5 (Step 6). Finally, a plurality of new dots is arranged by the dot arrangement means 40 on the trajectory Ck′ corrected in Step 6 according to the length of the trajectory Ck′ (Step 7).

According to the embodiment described above, when correcting a curved line displayed on an image display device and formed of a plurality of dots by moving a dot selected from the plurality of dots, a portion of the trajectory of the curved line is corrected such that the trajectory passes those of the plurality of dots located outside of the adjacent region of the selected dot before the dot is moved and a position of the selected dot after moved, and a plurality of new dots is arranged on the corrected portion of the trajectory according to the length thereof. This allows the dots on the curved line to be constantly maintained in a predetermined distribution before and after correction, thereby work efficiency of an operator may be improved. Further, the spacing between adjacent dots is maintained at or less than a predetermined value, so that a correction may be performed at any position on the curved line in the subsection correction.

In particular, when obtaining a contour of a target region, such as a region of a predetermined organ or blood vessel in each of a plurality of serial cross-sectional images obtained by helical scanning, multi slice CT, or the like, and three-dimensionally reconstructing the target region, it is often the case that by deforming a curved line representing a contour of the target region obtained from a certain tomography image bit by bit, contours appropriate for serial cross-sectional images may be obtained one after another. In repeatedly performed corrections, the curved line correction apparatus of the present invention allows a correction at any position on the curved line and the dots on the curved line are constantly maintained in a predetermined distribution, so that a contour appropriate for each of the tomography images may be obtained easily.

What is claimed is:

1. A curved line correction method for correcting a curved line displayed on an image display device and formed of a plurality of dots by moving a dot selected from the plurality of dots, the method comprising the steps of:
correcting a portion of the trajectory of the curved line such that the trajectory passes those of the plurality of dots located outside of an adjacent region of the selected dot before the dot is moved and a position of the selected dot after moved; and
arranging a plurality of new dots on the corrected portion of the trajectory according to the length thereof.

2. A curved line correction apparatus for correcting a curved line displayed on an image display device and formed of a plurality of dots by moving a dot selected from the plurality of dots, the apparatus comprising:
a trajectory correction means for correcting a portion of the trajectory of the curved line such that the trajectory passes those of the plurality of dots located outside of an adjacent region of the selected dot before the dot is moved and a position of the selected dot after moved; and
a dot arrangement means for arranging a plurality of new dots on the corrected portion of the trajectory according to the length thereof.

3. A computer readable recording medium on which a curved line correction program for causing a computer to perform a curved line correction method for correcting a curved line displayed on an image display device and formed of a plurality of dots by moving a dot selected from the plurality of dots, the method comprising the steps of:
correcting a portion of the trajectory of the curved line such that the trajectory passes those of the plurality of dots located outside of an adjacent region of the selected dot before the dot is moved and a position of the selected dot after moved; and
arranging a plurality of new dots on the corrected portion of the trajectory according to the length thereof.
